(19) United States
(12) Patent Application Publication
(10) Pub. No.: US 2016/0209707 A1
(43) Pub. Date: Jul. 21, 2016

(54) LIQUID CRYSTAL DISPLAY AND MANUFACTURING METHOD OF MAKING THE LIQUID CRYSTAL DISPLAY

(71) Applicant: Samsung Display Co., Ltd., Yongin-si (KR)

(72) Inventor: Duck Jong SUH, Seoul (KR)

(21) Appl. No.: 14/933,627

(22) Filed: Nov. 5, 2015

(30) Foreign Application Priority Data
Jan. 21, 2015 (KR) 10-2015-0010084

(51) Int. Cl. G02F 1/1337; G02F 1/1333; C09K 19/54; G02F 1/1341

(52) U.S. Cl. CPC G02F 1/133711; G02F 1/1341; G02F 1/133788; G02F 1/133382; C09K 19/54; G02F 2001/133726

(57) ABSTRACT

An exemplary embodiment of the present invention provides a liquid crystal display including: a first substrate; a second substrate facing the first substrate; a pixel electrode disposed on the first substrate; a common electrode disposed on the first substrate or the second substrate; a first alignment layer disposed on the first substrate, and including a first additive; a second alignment layer disposed on the second substrate, and including a second additive; and a liquid crystal layer disposed between the first substrate and the second substrate, wherein each of the first additive and the second additive contains different compounds from each other and represented by the following Chemical Formula 1, and wherein a molecular weight of the second additive is greater than that of the first additive:

P-Q-R-S-R-Q-P [Chemical Formula 1]

wherein P, Q, R, and S are the same as described in the detailed description section of the present specification.

### CLAIM PRIORITY

This application makes reference to, incorporates into this specification the entire contents of, and claims all benefits accruing under 35 U.S.C. §119 from an application LIQUID CRYSTAL DISPLAY AND MANUFACTURING METHOD OF MAKING THE LIQUID CRYSTAL DISPLAY earlier filed, in the Korean Intellectual Property Office on Jan. 21, 2015 and there duly assigned Serial No. 10-2015-0010084.

### BACKGROUND OF THE INVENTION

1. Field of the Invention

The present invention relates to a liquid crystal display including an alignment layer, and a manufacturing method of making the liquid crystal display thereof.

2. Description of the Related Art

As one of the most widely used flat panel displays at present, a liquid crystal display (LCD) includes two display panels on which field-generating electrodes such as a pixel electrode and a common electrode are formed, and a liquid crystal layer interposed between the two display panels. The LCD displays an image by generating an electric field on a liquid crystal layer by applying a voltage to the field-generating electrodes, determining alignment directions of liquid crystal molecules of the liquid crystal layer using the generated field, and controlling polarization of incident light.

Among the LCDs, a vertically aligned mode LCD, in which liquid crystal molecules are aligned so that their long axes are perpendicular to the upper and lower panels while no electric field is applied, has been In the limelight because its contrast ratio is high and a wide reference viewing angle is easily implemented.

In such a vertical alignment mode LCD, a plurality of domains in which alignment directions of liquid crystals are different may be formed in one pixel to implement a wide viewing angle.

The liquid crystal display in the vertically aligned mode may have degraded side visibility compared to front visibility. To solve the problem, a method of dividing the one pixel into two subpixels and making voltages of the two subpixels different has been proposed.

Meanwhile, a method that adds a reactive mesogen to an alignment layer or a liquid crystal layer such that the liquid crystals have pretilts has been developed to improve a response speed of the liquid crystals as well as to implement a wide viewing angle.

The above information disclosed in this Background section is only for enhancement of understanding of the background of the present invention and therefore it may contain information that does not form the prior art that is already known in this country to a person of ordinary skill in the art.

### SUMMARY OF THE INVENTION

The present invention has been made in an effort to provide a liquid crystal display including an alignment layer and a manufacturing method making the liquid crystal display thereof that may improve afterimages in a flat liquid crystal display or a curved liquid crystal display by containing different additives in alignment layers of an upper substrate and a lower substrate thereof.

An exemplary embodiment of the present invention may provide a liquid crystal display including: a first substrate; a second substrate facing the first substrate; a pixel electrode disposed on the first substrate; a common electrode disposed on the first substrate or the second substrate; a first alignment layer disposed on the first substrate, and including a first additive; a second alignment layer disposed on the second substrate, and including a second additive: and a liquid crystal layer disposed between the first substrate and the second substrate, wherein each of the first additive and the second additive contains different compounds from each other and the compounds are represented by the following Chemical Formula 1, and a molecular weight of the second additive is greater than that of the first additive.

P-Q-R-S-R-Q-P [Chemical Formula 1]

Herein, S in Chemical Formula 1 may include at least one of compounds represented by the following Chemical Formulae:

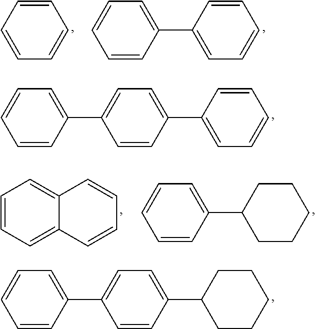

P in Chemical Formula 1 may include at least one of compounds represented by the following Chemical Formulae:

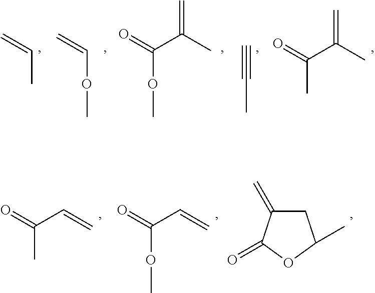

R in Chemical Formula 1 may include at least one of compounds represented by the following Chemical Formulae:

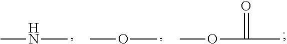

and Q in Chemical Formula 1 may include a compound represented by the following Chemical Formula:

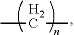

where n is an integer of 1 or more.

In some embodiments, n of the second additive may be an integer that is 2 or more greater than n of the first additive.

In some embodiments, the first additive may be a compound represented by the following Chemical Formula 2.

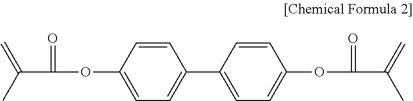 [SMILES: C=C(C)C(=O)Oc1ccc(-c2ccc(OC(=O)C(=C)C)cc2)cc1]

In some embodiments, the second additive may be a compound represented by the following Chemical Formula 3.

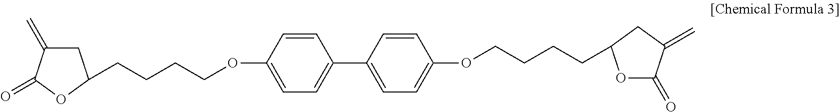 [SMILES: C=C1CC(CCCCOc2ccc(-c3ccc(OCCCCC4CC(=C)C(=O)O4)cc3)cc2)OC1=O]

In some embodiments, the first additive may be 5-15 wt % of the first alignment layer, and the second additive may be 5-15 wt % of the second alignment layer.

In some embodiments, the first alignment layer and the second alignment layer may include: a main chain, a plurality of side chains connected to the main chain, and an additive; and at least one of the side chains may contain a vertical expression group, and a reactive mesogen (RM) including a photoreactive group.

In some embodiments, the first alignment layer and the second alignment layer may contain a diamine compound and a dianhydride compound, and the diamine compound and the dianhydride compound may be contained at a 1:1 mole ratio therein.

In some embodiments, the photoreactive group may contain a photoinitiator, and the photoinitiator may contain a benzophenone-based compound.

In some embodiments, the photoinitiator may contain 20-50 mol % of the diamine compound.

In some embodiments, the first alignment layer and the second alignment layer may contain at least one of compounds represented by the following Chemical Formula 4 and Chemical Formula 5.

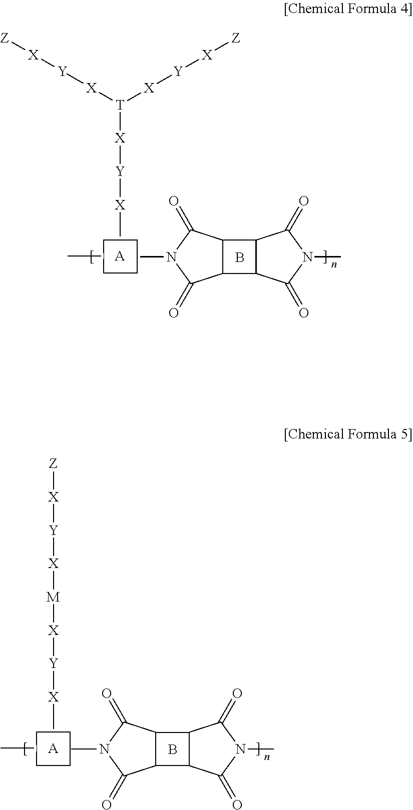

In Chemical Formulae 4 and 5, A may include at least one of compounds represented by the following Chemical Formulae:

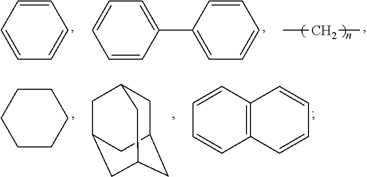

B may include at least one of compounds represented by the following Chemical Formulae:

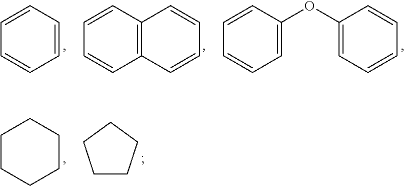

X independently may include at least one of compounds represented by the following Chemical Formulae:

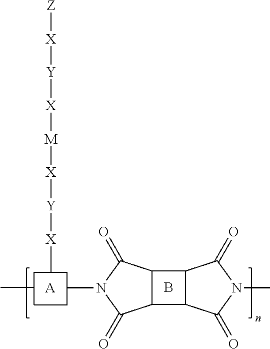

Y independently may include at least one of compounds represented by the following Chemical Formulae:

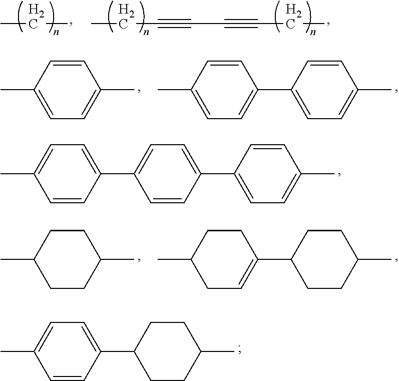

independently may include at least one of compounds represented by the following Chemical Formulae:

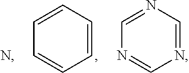

M independently may include at least one of compounds represented by the following Chemical Formulae:

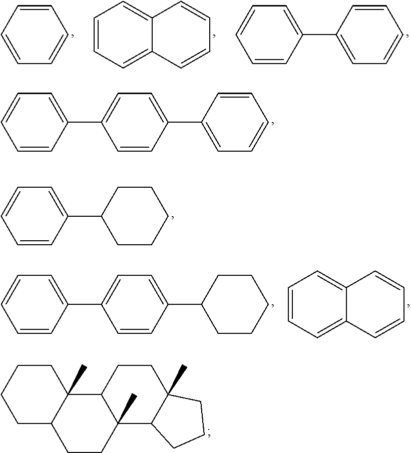

and Z independently may include at least one of compounds represented by the following Chemical Formulae:

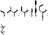

where n is an integer of 1 or more.

Another embodiment of the present invention may provide a manufacturing method of a liquid crystal display, including: forming a pixel electrode on a first substrate; forming a common electrode on the first substrate or on a second substrate facing the first substrate: and forming a first alignment layer containing a first additive on the first substrate, and a second alignment layer containing a second additive on the second substrate, respectively, wherein each of the first additive and the second additive contains different compounds from each other and the compounds are represented by Chemical Formula 1, and wherein a molecular weight of the second additive is greater than that of the first additive.

In some embodiments, the manufacturing method may further include: injecting a liquid crystal layer between the first substrate and the second substrate after forming the alignment layer; applying a predetermined voltage to the field-generating electrode; performing heat treatment for the first substrate and the second substrate; and irradiating light to the first substrate and the second substrate.

According to the embodiment of the present invention, it is possible to improve afterimages in a flat liquid crystal display or a curved liquid crystal display by containing different additives in alignment Savers of the upper substrate and the lower substrate thereof.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a cross-sectional view illustrating a process using an alignment layer including an additive such that liquid crystal molecules have pretilts according to an embodiment of the present invention.

FIG. 2 is a schematic view illustrating a structure of an alignment layer according to an embodiment of the present invention.

FIG. 3 is a schematic view illustrating a process using an alignment layer including an additive such that liquid crystal molecules have pretilts according to an embodiment of the present invention.

FIG. 4A is a schematic view of liquid crystal molecules having pretilts according to an embodiment of the present invention.

FIG. 4B is a photograph showing a texture when using an alignment layer according to an embodiment of the present invention.

FIG. 5A is a schematic view of liquid crystal molecules having pretilts according to an embodiment of the present invention.

FIG. 5B is a photograph showing a texture when using an alignment layer according to an embodiment of the present invention.

FIG. 6 is a layout view of one pixel of a liquid crystal display according to an embodiment of the present invention.

FIG. 7 is a cross-sectional view of FIG. 6 taken along line VII-VII.

FIG. 8 is a top plan view of basic regions of a pixel electrode of a liquid crystal display according to an embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

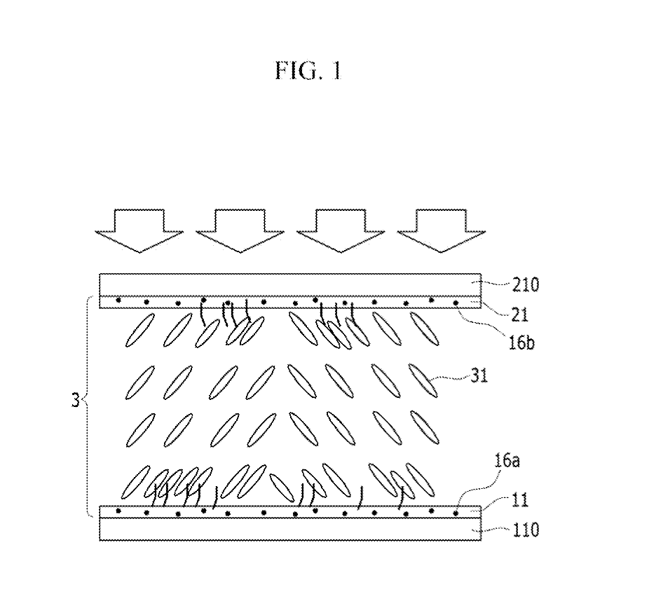

First, alignment layers 11 and 21, and a method that uses the alignment layers 11 and 21 for liquid crystal molecules 31 to have pretilts according to an embodiment of the present invention, will be described with reference to FIGS. 1 to 3.

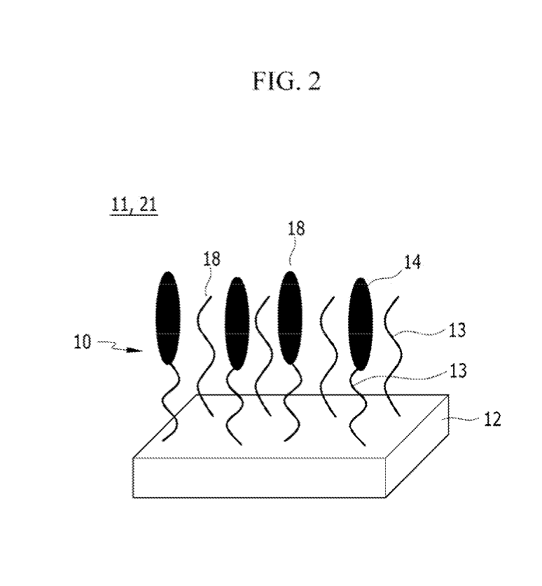

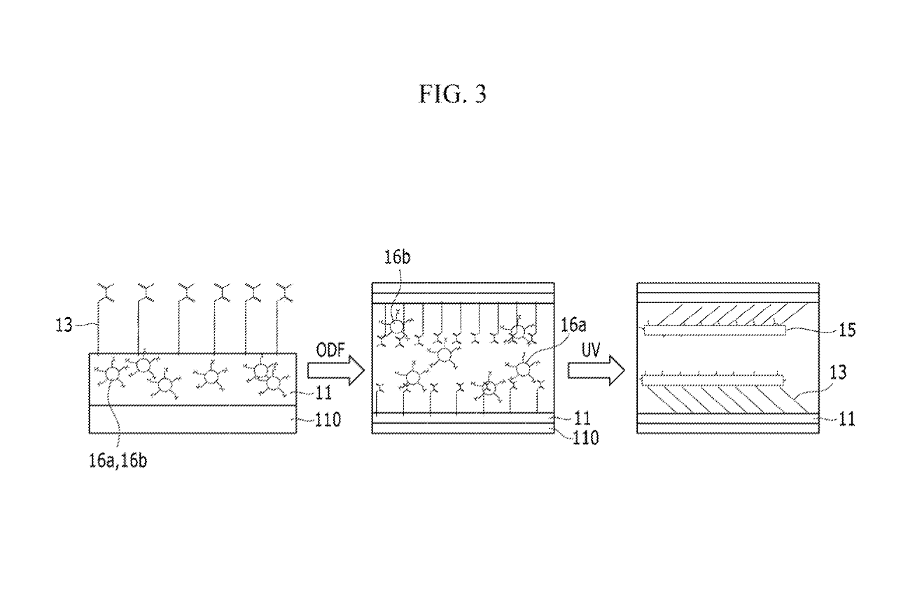

FIG. 1 is a cross-sectional view illustrating a process using an alignment layer including an additive such that liquid crystal molecules have pretilts according to an embodiment of the present invention, FIG. 2 is a schematic view illustrating a structure of an alignment layer according to an embodiment of the present invention, and FIG. 3 is a schematic view illustrating a process using an alignment layer including an additive such that liquid crystal molecules have pretilts according to an embodiment of the present invention.

First, referring to FIG. 1, the alignment layers 11 and 21 containing a first additive (16a) and a second additive (16b), are respectively formed on two display substrates 110 and 210, and a liquid crystal layer 3 containing liquid crystal molecules 31 are formed between the two display substrates 110 and 210. Further, referring to FIG. 1, the additives (16a and 16b) may be contained in the alignment layers 11 and 21.

Referring to FIG. 2, the alignment layers 11 and 21 may include a main chain 12, and a plurality of side chains 18 connected to the main chain 12. At least one of the side chains 18 may include a reactive mesogen (RM) 10 having a photoreactive group 14, and a vertical expression group 13, and the like. The reactive mesogen 10 may include one or more photoreactive groups 14. FIG. 2 illustrates the presence of one photoreactive group 14 in the reactive mesogen 10, however the number of photoreactive groups 14 may be more than one in the reactive mesogen 10.

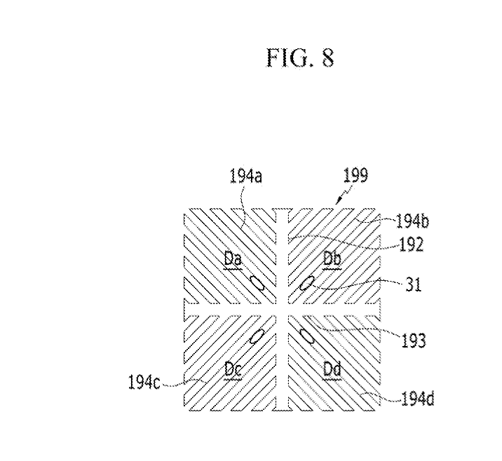

Once the alignment layers 11 and 21 containing the first additive (16a) and the second additive (16b) are formed on the display substrates 110 and 210, a data voltage may be applied to a pixel electrode 191 of the display substrate 110 (that is, a lower display substrate), and a common voltage may be applied to a common electrode 270 of the display substrate 210 (that is, an upper display substrate) to generate an electric field in the liquid crystal layer 3 containing liquid crystal molecules 31 between the two display substrates 110 and 210. Then, the liquid crystal molecules 31 may respond to the electric field to be inclined in a direction that is parallel to length directions of minute branch portions 194a, 194b, 194c, and 194d (see FIG. 8) formed on the pixel electrode 191. In this case, the total number of inclination directions of the liquid crystal molecules 31 in one pixel may be four.

Referring to FIGS. 1 and 3, after generating the electric field in the liquid crystal layer 3 and performing heat treatment for additives 16a and 16b to flow into the liquid crystal layer 3, when light such as ultraviolet rays is irradiated thereon, the photoreactive groups 14 contained in the reactive mesogens 10 may be reacted with each other to form a cross-linking portion 15 as illustrated in FIG. 3. The cross-linking portion 15 may have a pretilt.

In addition, as shown in FIG. 3, due to the heat treatment, the additives 16a and 16b contained in the alignment layers 11 and 21 according to the embodiment of the present invention may be dissolved out into the liquid crystal layer 3 so that the liquid crystal molecules 31 may be reacted with the reactive mesogens 10 of the alignment layers 11 and 21 in the light irradiation process. The additives 16a and 16b may be compounds having photoreactive groups, and the photoreactive groups of the additives 16a and 16b may be reacted with the photoreactive groups 14 of the reactive mesogens 10 to form the cross-linking portion 15. Accordingly, as compared with cases in which the additives are not present in the alignment layer, the degree of cross-linking between the reactive mesogens 10 increases according to the embodiment of the present invention.

That is, bonding of the cross-linking portion 15 may be strengthened, a modulus may be increased by improvement of the degree of cross-linking, and mechanical properties may be improved, and thus, thereafter, a black afterimage and an instantaneous afterimage may be improved.

As described above, when the light such as the ultraviolet, rays is irradiated after the electric field is generated in the liquid crystal layer 3 including the liquid crystal molecules 31, since the photoreactive groups 14 contained in the reactive mesogens 10 are reacted with each other to form an alignment polymer, a pretilt of an initial aligning direction may be controlled by the alignment polymer.

Hereinafter, the alignment layers 11 and 21 according to the embodiment of the present invention will be described in more detail.

The alignment layers 11 and 21 according to the embodiment of the present invention may include a main chain 12, and a plurality of side chains 18 connected to the main chain 12, and the additives 16a and 16b.

First, the additives 16a and 16b will be described. The alignment layers 11 and 21 according to the embodiment of the present invention may respectively contain the additives 16a and 16b therein, and the additives 16a and 16b may be dissolved out into the liquid crystal layer 3 in the light irradiation process to be reacted with the reactive mesogens 10 including the photoreactive groups 14.

Each of the additives 16a and 16b may be a material having several photoreactive groups, and the photoreactive groups of the additives 16a and 16b may be reacted with the photoreactive groups 14 of the reactive mesogens 14, or the photoreactive groups of the additives 16a and 16b may be reacted with each other. After light is irradiated, a residual additive that is not reacted but remains may be removed in a fluorescent UV process.

The first alignment layer 11 and the second alignment layer 21 according to the embodiment of the present invention may respectively include the first additive 16a and the second additive 16b to have different moduli from each other.

Since bonding force for the cross-linking portion 15 of the second alignment layer 21 with the second additive 16b is weaker than that of the first alignment layer 11 with the first additive 16a, a modulus of the second alignment layer 21 may be formed to be relatively small.

In the embodiment of the present invention, the first and second additives 16a and 16b included in the first and second alignment layers 11 and 21 may be at least one of compounds represented by the following Chemical Formula 1.

P-Q-R-S-R-Q-P [Chemical Formula 1]

S in Chemical Formula 1 may include at least one of compounds represented by the following Chemical Formulae:

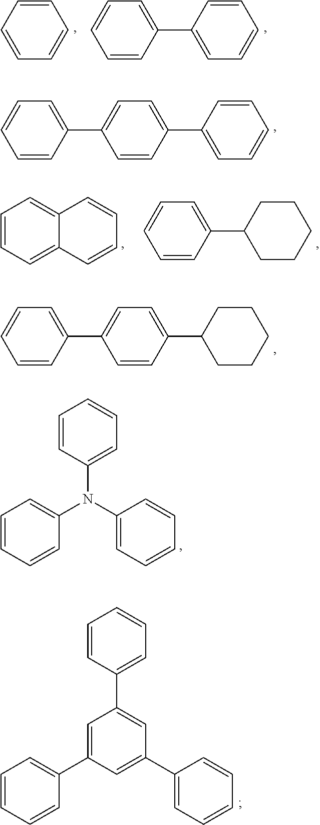

P in Chemical Formula 1 may include at least one of compounds represented by the following Chemical Formulae:

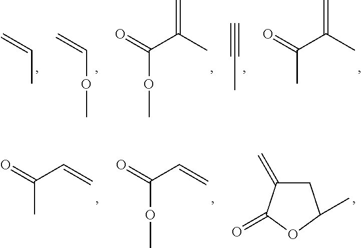

R in Chemical Formula 1 may include at least one of compounds represented by the following Chemical Formulae:

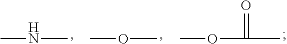

and Q in Chemical Formula 1 may include a compound represented by the following Chemical Formula:

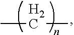

where n is an integer of 1 or more.

A molecular weight of the second additive 16b may be greater than that of the first additive 16a.

In the exemplary embodiment, the first additive 16a may be a compound represented by the following Chemical Formula 2, and the second additive 16b may be a compound represented by the following Chemical Formula 3, however the additives are not limited thereto.

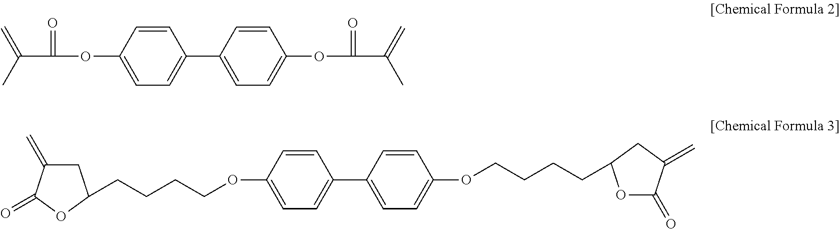 [SMILES: C=C(C)C(=O)Oc1ccc(-c2ccc(OC(=O)C(=C)C)cc2)cc1 ; C=C1CC(CCCCOc2ccc(-c3ccc(OCCCCC4CC(=C)C(=O)O4)cc3)cc2)OC1=O]

“n” (hereinafter referred to as NB) of the Q of the second additive 16b may be an integer that is 2 or more greater than “n” (hereinafter referred to as MA) of the Q of the first additive 16a.

When the first additive 16a is the compound represented by Chemical Formula 2, the NA is 0, and when the second additive 16b is the compound represented by Chemical Formula 3, the NB is 2. Accordingly, a modulus of the second alignment layer 21 including the second additive 16b may be relatively weakly formed compared with a modulus of the first alignment layer 11.

In other words, the NB of the second additive 16b may be an integer that is 2 or more greater than the NA of the first additive 16a when the second additive 16b is compared with the first additive 16a based on Chemical Formula 1.

The content of the additive 16a may be greater than 5 wt % and less than 15 wt % of the first alignment layer 11, but it is not limited thereto. The content of the additive 16b may be greater than 5 wt % and less than 15 wt % of the second alignment layer 21, but it is not limited thereto. This is because implementation of a pretilt is difficult when the content of the additives 16a and 16b is less than or equal to 5 wt % of the first alignment layer 11 or the second alignment layer 21, and a residual additive that is not reacted may occur when the content of the additives 16a and 16b is more than or equal to 15 wt % thereof.

Next, a main chain 12 and a plurality of side chains 18 connected to the main chain 12 of the alignment layers 11 and 21 according to the embodiment of the present invention will be described.

In the embodiment of the present invention, the main chain 12 may include a dianhydride compound, a diamine compound, and the like.

At least one of side chains 18 may include a vertical expression group 13 connected to the main chain 12, or a reactive mesogen 10 including a photoreactive group 14 connected to the vertical expression group 13. That is, a portion of the side chains 18 may include only the vertical expression group 13, and the remaining portion of the side chains 18 may be the reactive mesogen 10 including the photoreactive group 14 connected to the vertical expression group 13.

The photoreactive groups 14 included in the reactive mesogen 10 may be connected to each other in one side of the vertical expression group 13, but a connecting method is not limited.

The alignment layers 11 and 21 including the reactive mesogen 10 may include one or more of compounds represented by the following Chemical Formula 4 and Chemical Formula 5, and the side chains 18 except for the main chain 12 correspond to the vertical expression group 13 and the photoreactive group 14 connected to the vertical expression group 13.

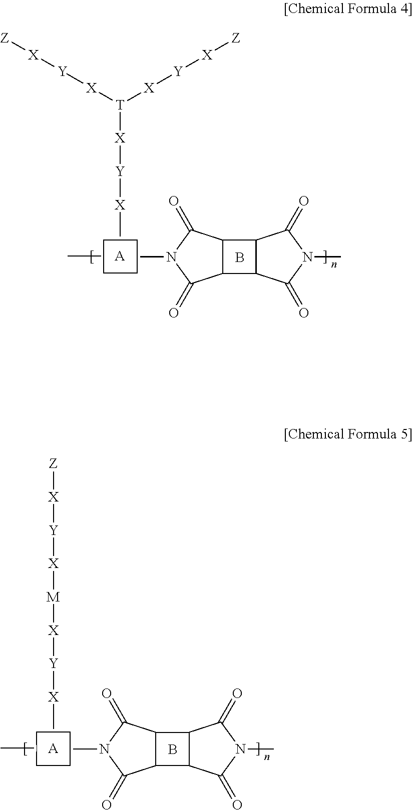

Herein, A may include at least one of compounds represented by the following Chemical Formulae:

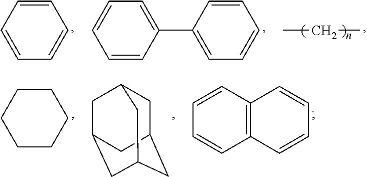

B may include at least one of compounds represented by the following Chemical Formulae:

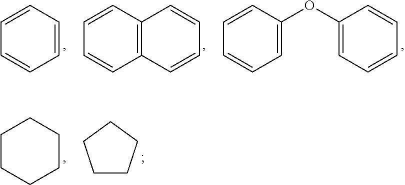

X may independently include at least one of compounds represented by the following Chemical Formulae:

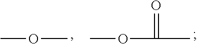

Y may independently include at least one of compounds represented by the following Chemical Formulae:

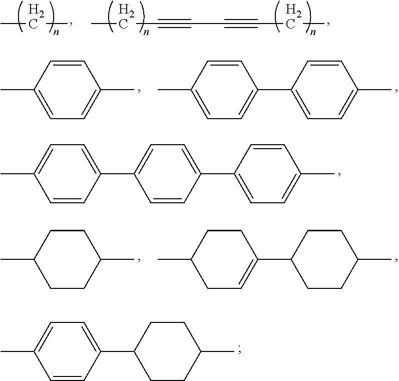

T may independently include at least one of compounds represented by the following Chemical Formulae:

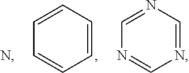

M may independently include at least one of compounds represented by the following Chemical Formulae:

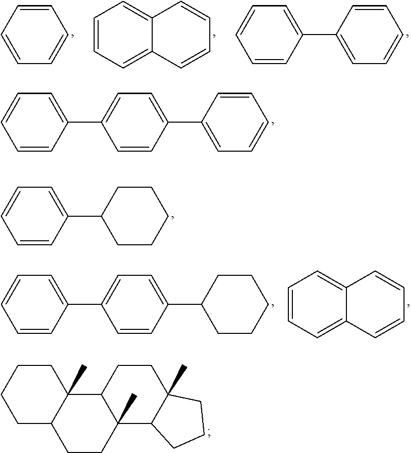

and Z may independently include at least one of compounds represented by the following Chemical Formulae:

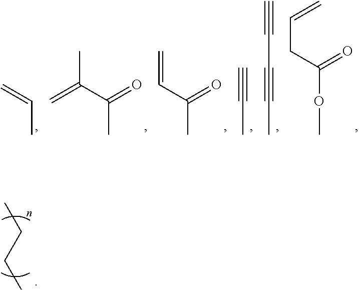

Y included in the side chain 18 in the compound represented by Chemical Formula 4 may be particularly represented by the following Chemical Formula:

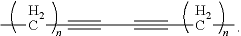

In the compound represented by Chemical Formula 5, a photoreactive group may be disposed in parallel with the vertical expression group.

In Chemical Formulae 4 and 5, Y and Z included in the reactive mesogen may be a photoreactive group. That is, in Y or Z including an unsaturated bond of a double bond or more, a photoreaction may occur.

A compound represented by Chemical Formula 4 may be a compound represented by the following Chemical Formula 6, and a compound represented by Chemical Formula 5 may be a compound represented by the following Chemical Formula 7. However, any combination of the aforementioned compounds is feasible, and the combination is not limited to Chemical formulae 6 and 7.

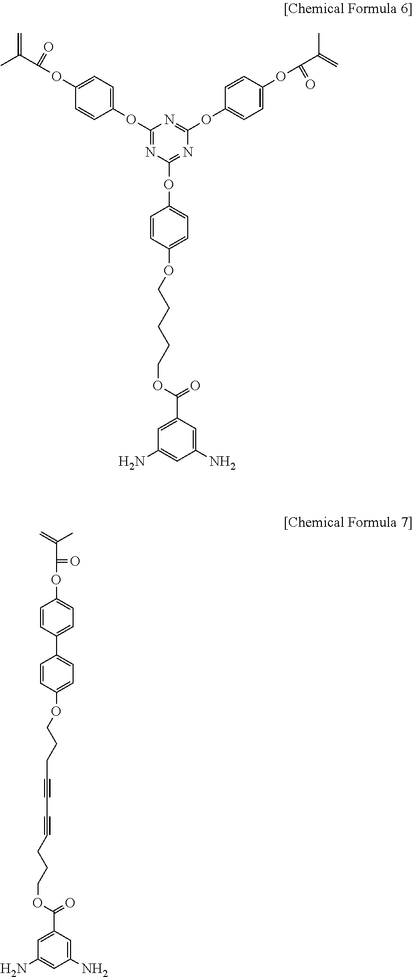 [SMILES: C=C(C)C(=O)Oc1ccc(Oc2nc(Oc3ccc(OCCCCCOC(=O)c4cc(N)cc(N)c4)cc3)nc(Oc3ccc(OC(=O)C(=C)C)cc3)n2)cc1 ; C=C(C)C(=O)Oc1ccc(-c2ccc(OCCCC#CC#CCCCOC(=O)c3cc(N)cc(N)c3)cc2)cc1]

Further, a compound of Chemical Formula 5 as an example of Chemical Formula 5 may be included in the alignment layer through the following Reaction Formula 1.

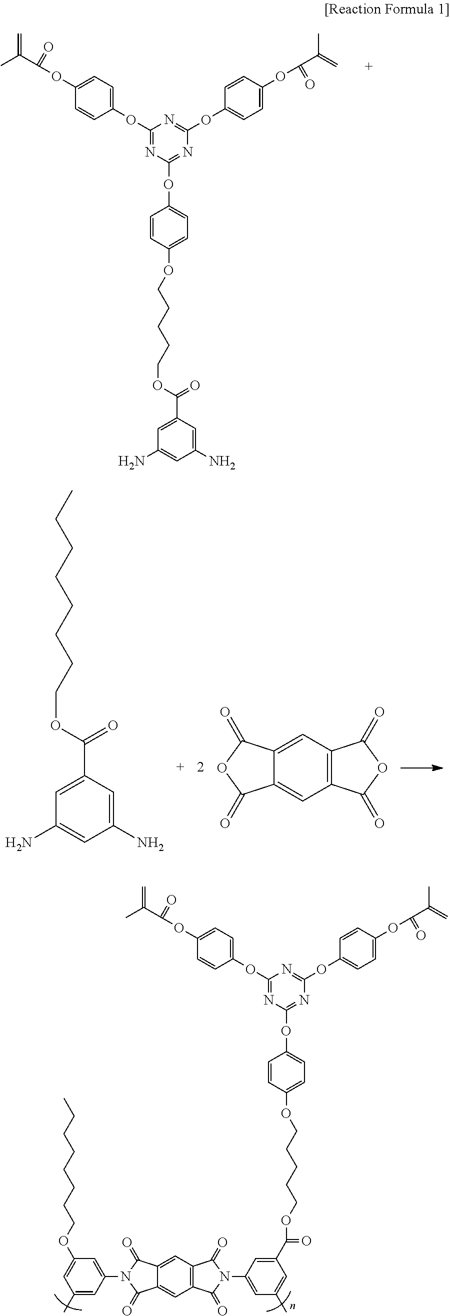

The alignment layers 11 and 21 may be formed by polymerizing the reactive mesogens 10 including the photoreactive groups 14 at opposing ends, the vertical expression groups 13, a diamine compound, a monomer including the vertical expression group 13 and the diamine compound, and a dianhydride compound. In this case, a mole ratio of the diamine compound and the dianhydride compound may be 1:1.

The photoreactive group 14 may include a photoinitiator, wherein the photoinitiator may be a benzophenone-based compound, and may include 20-50 mol % of the diamine compound. This is because vertical alignment ability may be reduced when the photoinitiator exceeds 50 mol % of the diamine compound.

A compound of Chemical Formula 7 that is an example of the Chemical Formula 5 may not be described through a separately illustrated formula, but may be drawn by substituting the reactive mesogen 10 represented by Chemical Formula 7 for the reactive mesogen 10 represented by Chemical Formula 6 in the aforementioned process.

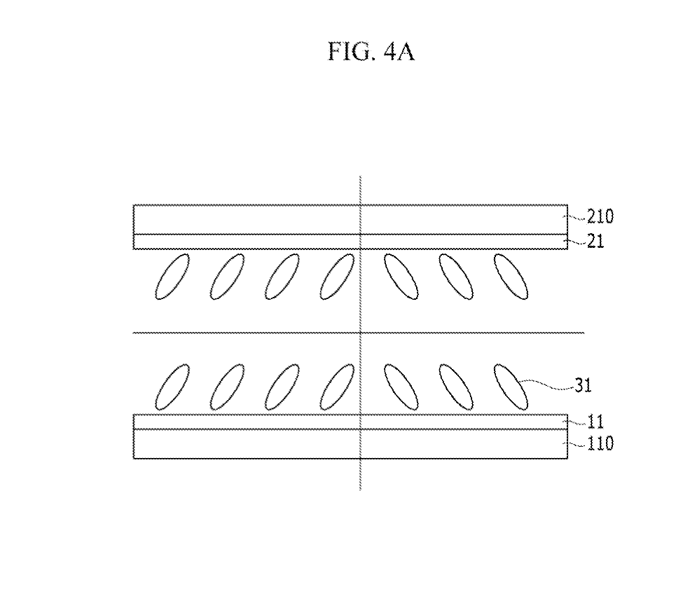

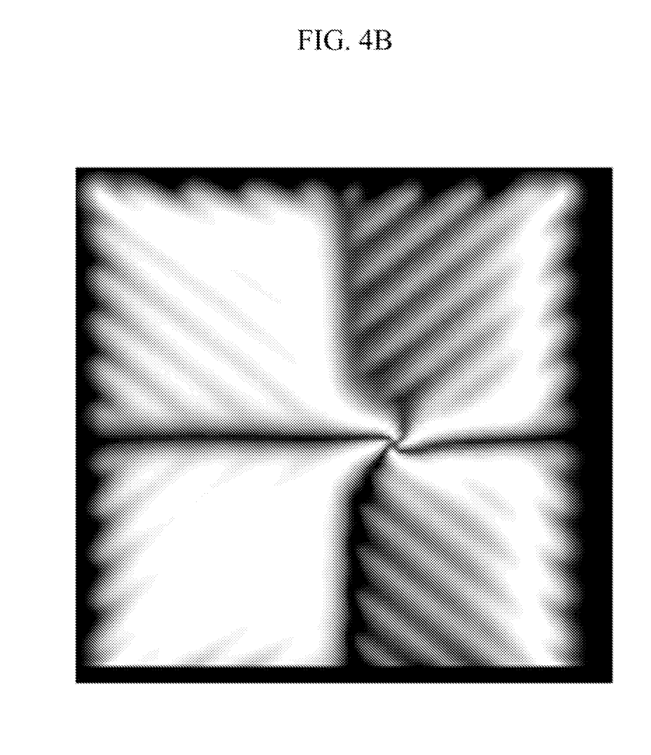

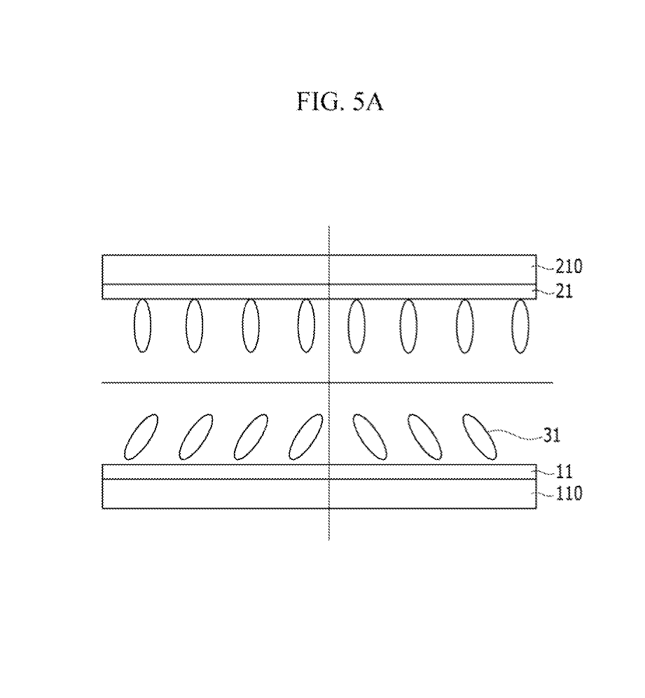

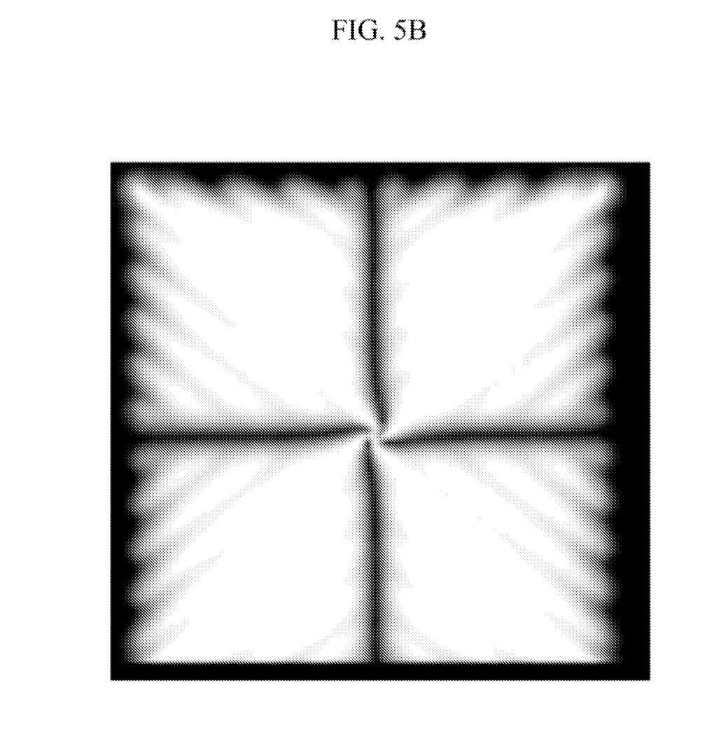

An effect by the first additive 16a and the second additive 16b differently included in the first alignment layer 11 and the second alignment layer 12 according to the embodiment of the present invention will be described in detail with reference to FIGS. 4 and 5.

FIG. 4A is a schematic view of liquid crystal molecules having pretilts and FIG. 4B is a photograph showing a texture when using the alignment layer according to the embodiment of the present invention, respectively.

FIG. 5A is a schematic view of liquid crystal molecules having pretilts and FIG. 5B is a photograph showing a texture when using the alignment layer according to the embodiment of the present invention, respectively.

First, referring to FIG. 4A, when the first and second alignment layers 11 and 21 are formed with the same material to have the same modulus, the liquid crystal molecules 31 may be inclined in a direction that is parallel to the length directions of the minute branch portions 194a, 194b, 194c, and 194d (see FIG. 8) formed at the pixel electrode 191, and the total number of inclination directions of the liquid crystal molecules 31 may be four.

In this case, when the upper and lower substrates 110 and 210 are twisted or formed with a curved surface, since regions of the liquid crystal molecules 31 formed in four different tilt directions may be partially overlapped with each other, the liquid crystal molecules 31 may not have a constant pretilt, and regions in which the liquid crystal molecules 31 having various pretilts that are mixed may occur, thereby producing afterimages as shown in FIG. 4B.

However, on the contrary, referring to FIG. 5A according to the embodiment of the present invention, the first and second additives 16a and 16b are differently included in the first and second alignment layers 11 and 21 to have different moduli from each other, and thus the liquid crystal molecules 31 disposed on the second alignment layer 21 in which a modulus is relatively small may have bad or weak pretilts.

In this case, even though the upper and lower substrates 110 and 210 are twisted or formed with a curved surface, since the modulus of the second alignment layer 11 is relatively small, the pretilts of the liquid crystal molecules 31 that are adjacent to the second alignment layer 21 may be formed depending on the pretilts of the liquid crystal molecules 31 that are adjacent to the first alignment layer 11.

Accordingly, regions in which the liquid crystal molecules 31 having various pretilts are mixed may not occur, thereby improving afterimages as shown in FIG. 5B.

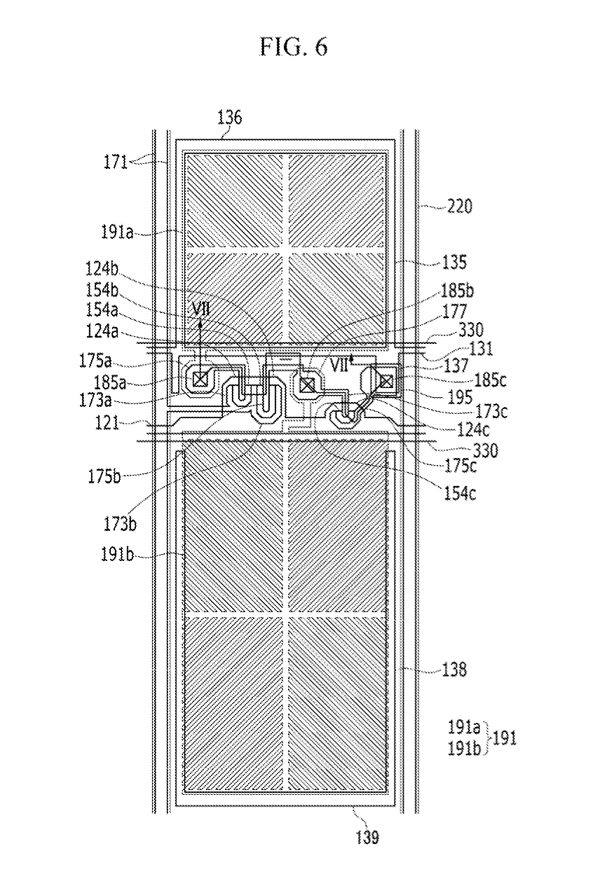

A structure of a liquid crystal display (LCD) according to the embodiment of the present invention will now be described with reference to FIGS. 6 to 8.

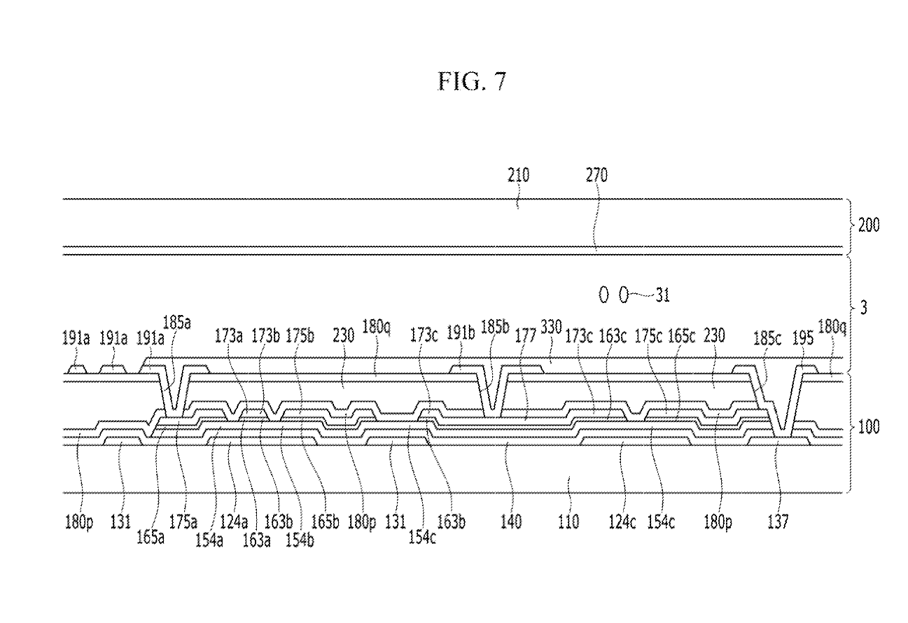

FIG. 6 is a layout view of one pixel of the LCD according to an embodiment of the present invention, FIG. 7 is a cross-sectional view of FIG. 6 taken along the line VII-VII, and FIG. 8 is a top plan view of basic regions of a pixel electrode of the LCD according to an embodiment of the present invention.

Referring to FIGS. 6 and 7, the LCD according to the present exemplary embodiment may include: a lower panel 100 and an upper panel 200 facing each other; a liquid crystal layer 3 interposed between the upper and lower panels 100 and 200; and a pair of polarizers (not shown) respectively attached to outer surfaces of the upper and lower panels 100 and 200.

The lower panel 100 will be described first.

A gate conductor including a gate line 121 and a divided reference voltage line 131 may be disposed on an insulation substrate (lower display substrate) 110 made of transparent glass or plastic.

The gate line 121 may include a first gate electrode 124a, a second gate electrode 124b, a third gate electrode 124c, and a wide end portion (not shown) for connection with another layer or an external driving circuit.

The divided reference voltage line 131 may include first storage electrodes 135 and 136, and a reference electrode 137. Though not connected to the divided reference voltage line 131, second storage electrodes 138 and 139 may be also disposed to overlap a second subpixel electrode 191b.

A gate insulating layer 140 may be disposed on the gate line 121 and the divided reference voltage line 131.

A first semiconductor layer 154a, a second semiconductor layer 154b, and a third semiconductor layer 154c may be disposed on the gate insulating layer 140.

A plurality of ohmic contacts 163a, 165a, 163b, 165b, 163c, and 165c may be disposed on the semiconductor layers 154a, 154b, and 154c.

A plurality of data lines 171 including first and second source electrodes 173a and 173b and a data conductor including a first drain electrode 175a, a second drain electrode 175b, a third source electrode 173c, and a third drain electrode 175c may be disposed on the ohmic contacts 163a, 165a, 163b, 165b, 163c, and 165c and the gate insulating layer 140.

The data conductor, and the semiconductor and the ohmic contacts disposed thereunder, may be simultaneously formed using one mask.

The data line 171 may include a wide end portion (not shown) for connection with another layer or an external driving circuit.

The first gate electrode 124a, the first source electrode 173a, and the first drain electrode 175a may form a first thin film transistor Qa along with the first semiconductor layer 154a, and a channel of the first thin film transistor may be formed at the first semiconductor layer 154a between the first source electrode 173a and the first drain electrode 175a. Similarly, the second gate electrode 124b, the second source electrode 173b, and the second drain electrode 175b may form a second thin film transistor Qb along with the second semiconductor layer 154b, and a channel thereof may be formed at the second semiconductor layer 154b between the second source electrode 173b and the second drain electrode 175b. The third gate electrode 124c, the third source electrode 173c, and the third drain electrode 175c may form a third thin film transistor Qc along with the third semiconductor layer 154c, and a channel thereof may be formed at the third semiconductor layer 154c between the third source electrode 173c and the third drain electrode 175c.

The second drain electrode 175b may be connected to the third source electrode 173c and includes a wide expansion 177.

A first passivation layer 180p may be disposed on the data conductors 171, 173c, 175a, 175b, and 175c and exposed portions of the semiconductor layers 154a, 154b, and 154c. The first passivation layer 180p may be an inorganic insulating layer that is formed of a silicon nitride or a silicon oxide. The first passivation layer 180p may prevent a pigment of a color filter 230 from flowing into the exposed, portions of the semiconductor layers 154a, 154b, and 154c.

A color filter 230 may be disposed on the first passivation layer 180p. The color filter 230 may vertically extend along two data lines that are adjacent to each other. A first light blocking member 220 may be disposed on the first passivation layer 180p, an edge of the color filter 230, and the data line 171.

A first light blocking member 220 may extend along the data line 171, and may be disposed between the two adjacent color filters 230. A width of the first light blocking member 220 may be greater than that of the data line 171. As such, since the width of the first light blocking member 220 is formed greater than that of the data line 171, the first light blocking member 220 may prevent incident light from the outside from being reflected from a metallic surface of the data line 171. Accordingly, because the light reflected from the surface of the data line 171 interferes with light passing through the liquid, crystal layer 3, a contrast ratio of the liquid crystal display may be thereby prevented from deteriorating.

A second passivation layer 180q may be formed on the color filter 230 and the first light blocking member 220.

The second passivation layer 180q may include an inorganic insulating layer that is formed of a silicon nitride, a silicon oxide, or the like. The second passivation layer 180q not only prevents the color filter 230 from being lifted but also suppresses contamination of the liquid crystal layer by an organic material such as a solvent introduced from the color filter 230, thereby preventing defects such as a residual image that can occur when a screen is driven.

A first contact hole 185a and a second contact hole 185b may be formed in the first and second passivation layers 180p and 180q to expose the first and second drain electrodes 175a and 175b, respectively.

A third contact hole 185c may be formed in the first passivation layer 180p, the second passivation layer 180q, and the gate insulating layer 140 to partially expose the reference electrode 137 and the third drain electrode 175c, and the third contact hole 185c may be covered with a connecting member 195. The connecting member 195 may electrically connect the reference electrode 137 and the third drain electrode 175c that are exposed through the third contact hole 185c.

A plurality of pixel electrodes 191 may be formed on the second passivation layer 180q. The pixel electrodes 191 may be separated from each other while interposing the gate line 121 therebetween, and may respectively include a first subpixel electrode 191a and a second subpixel electrode 191b that neighbor each other in a column direction based on the gate line 121. The pixel electrode 191 may be formed of a transparent material such as ITO or IZO. The pixel electrode 191 may be formed of a transparent conductive material such as ITO or IZO, or a reflective metal such as aluminum, silver, chromium, or an alloy thereof.

The first and second subpixel electrodes 191a and 191b may respectively include one or more basic electrodes 199 illustrated in FIG. 6 or variations thereof.

The first and second subpixel electrodes 191a and 191b may be physically and electrically connected to the first and second drain electrodes 175a and 175b through the first and second contact holes 185a and 185b, and may be applied with the data voltage from the first and second drain electrodes 175a and 175b, respectively. In this case, the data voltage applied to the second drain electrode 175b may be partially divided by the third source electrode 173c such that the voltage applied to the first subpixel electrode 191a is greater than that applied to the second subpixel electrode 191b.

Along with a common electrode 270 of the upper panel 200, the first and second subpixel electrodes 191a and 191b to which the data voltage is applied may generate an electric field, thereby determining directions of liquid crystal molecules 31 of the liquid crystal layer 3 between the two electrodes 191 and 270. Depending on the directions of the liquid crystal molecules 31 determined as such, luminance of light passing through the liquid crystal layer 3 may be changed.

A second light blocking member 330 may be disposed on the pixel electrode 191. The second light blocking member 330 may be formed to cover an entire area where the first transistor Qa, the second transistor Qb, and the third transistor Qc and the first to third contact holes 185a, 185b, and 185c are disposed, and extends in the same direction as the gate line 121, thereby partially overlapping the data line 171. The second light blocking member 330 may be disposed to at least partially overlap the two data lines 171 that are disposed at opposite lateral sides of one pixel area, and prevents leakage of light that can occur near the data line 171 and the gate line 121 and near an area where the first transistor Qa, the second transistor Qb, and the third transistor Qc are disposed.

Until the second light blocking member 330 is formed, the first passivation layer 180p, the color filter 230, and the second passivation layer 180q may be disposed in the area where the first transistor Qa, the second transistor Qb, and the third transistor Qc are disposed, such that positions of the first transistor Qa, the second transistor Qb, the third transistor Qc, and the first to third contact holes 185a, 185b, and 185c can be easily discriminated.

The first alignment layer 11 including the first additive 16a may be disposed on the second light blocking member 330.

The upper panel 200 will now be described.

The common electrode 270 may be formed on an insulation substrate (upper display substrate) 210. The second alignment layer 21 including the second additive 16b may be formed on the common electrode 270.

In the embodiment of the present invention, the first and second additives 16a and 16b respectively included in the first and second alignment layers 11 and 21 may be a compound represented by the following Chemical Formula 1.

P-Q-R-S-R-Q-P [Chemical Formula 1]

S in Chemical Formula 1 may include at least one of compounds represented by the following Chemical Formulae:

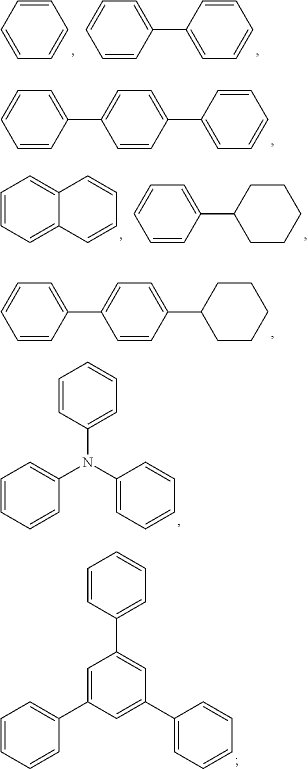

P in Chemical Formula 1 may include at least one of compounds represented by the following Chemical Formulae:

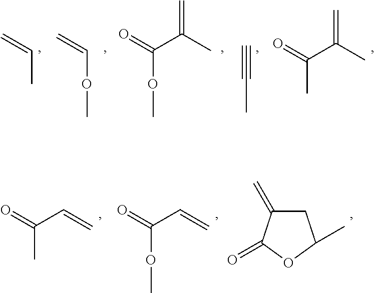

R in Chemical Formula 1 may include at least one of compounds represented by the following Chemical Formula:

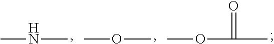

and Q in Chemical Formula 1 may include a compound represented by the following Chemical Formula:

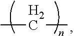

where n is an integer of 1 or more.

A molecular weight of the second additive 16b may be greater than that of the first additive 16a.

In the exemplary embodiment, the first additive 16a may be a compound represented by the following Chemical Formula 2, and the second additive 16b may be a compound represented by the following Chemical Formula 3, however the additives are not limited thereto.

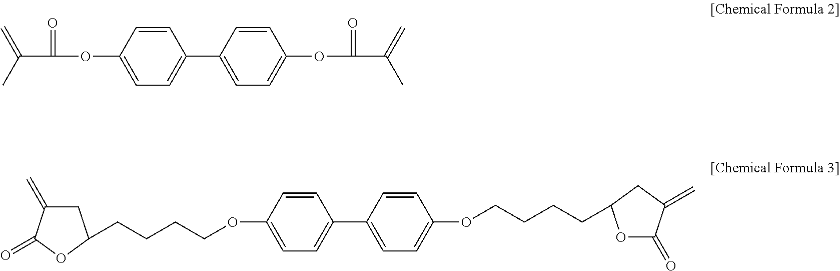 [SMILES: C=C(C)C(=O)Oc1ccc(-c2ccc(OC(=O)C(=C)C)cc2)cc1 ; C=C1CC(CCCCOc2ccc(-c3ccc(OCCCCC4CC(=C)C(=O)O4)cc3)cc2)OC1=O]

“n” (hereinafter referred to as NB) of the Q of the second additive 16b may be 2 or more greater than “n” (hereinafter referred to as NA) of the Q of the first additive 16a.

When the first additive 16a is the compound represented by Chemical Formula 2, the NA is 0, and when the second additive 16b is the compound represented by Chemical Formula 3, the NB is 2. Accordingly, a modulus of the second alignment layer 21 including the second additive 16b may be relatively weakly formed compared with a modulus of the first alignment layer 11.

In other words, the NB of the second additive 16b may be 2 or more greater than the NA of the first additive 16a when the second additive 16b is compared with the first additive 16a based on Chemical Formula 1.

The content of the additives 16a and 16b may be greater than 5 wt % and less than 15 wt % of the first alignment layer 11 or the second alignment layer 21, but it is not limited thereto. This is because implementation of a pretilt is difficult when the content of the additives 16a and 16b is less than or equal to 5 wt % of the first alignment layer 11 or the second alignment layer 21, and a residual additive that, is not reacted may occur when the content of the additives 16a and 16b is more than or equal to 15 wt % thereof.

The liquid crystal layer 3 may have negative dielectric anisotropy, and the liquid crystal molecules 31 of the liquid crystal layer 3 may be aligned such that their long axes are perpendicular to surfaces of the two display panels 100 and 200 when no electric field is present.

A basic electrode 199 will now be described with reference to FIG. 8.

As shown in FIG. 8, the basic electrode 199 may have an overall quadrangular shape, and may include a cross-shaped stem portion that consists of a horizontal stem portion 193 and a vertical stem portion 192 perpendicular thereto. In addition, the basic electrode 199 may be divided into a first subregion Da, a second subregion Db, a third subregion Dc, and a fourth subregion Dd by the horizontal stem portion 193 and the vertical stem portion 192, and each of the subregions Da to Dd may include a plurality of first minute branch portions 194a, a plurality of second minute branch portions 194b, a plurality of third minute branch portions 194c, and a plurality of fourth minute branch portions 194d.

The first minute branch portions 194a may obliquely extend from the horizontal stem portion 193 or the vertical stem portion 192 in an upper left direction, and the second minute branch portions 194b may obliquely extend from the horizontal stem portion 193 or the vertical stem portion 192 in an upper right direction. The third minute branch portion 194c may obliquely extend from the horizontal stem portion 193 or the vertical stem portion 192 in a lower left direction, and the fourth minute branch portion 194d may obliquely extend from the horizontal stem portion 193 or the vertical stem portion 192 in a lower right direction.

The first to fourth minute branch portions 194a, 194b, 194c, and 194d may form an angle of about 45° or 135° with the gate lines or the horizontal stem portion 193. In addition, the minute branch portions 194a, 194b, 194c, and 194d of the two neighboring subregions Da, Db, Dc, and Dd may be perpendicular to each other.

The minute branch portions 194a, 194b, 194c, and 194d may have a width of 2.5 μm to 5.0 μm, and may interval between the neighboring minute branch portions 194a, 194b, 194c, and 194d within each of the subregions Da, Db, Dc, and Dd may be 2.5 μm to 5.0 μm.

According to another embodiment of the present invention, the widths of the minute branch portions 194a, 194b, 194c, and 194d may become greater closer to the horizontal stem portion 193 or the vertical stem portion 192, and a difference between the widest and the narrowest portions of the minute branch portions 194a, 194b, 194c, and 194d may be 0.2 μm to 1.5 μm.

The first and second subpixel electrodes 191a and 191b may be respectively connected to the first and second drain electrodes 175a and 175b through the first and second contact holes 185a and 185b such that they are applied with the data voltage from the first and second drain electrodes 175a and 175b. In this case, sides of the first to fourth minute branch portions 194a, 194b, 194c, and 194d may distort an electric field to generate a horizontal component that determines tilt directions of the liquid crystal molecules 31. The horizontal component of the electric field may be nearly parallel to the sides of the first to fourth minute branch portions 194a, 194b, 194c, and 194d.

Accordingly, as shown in FIG. 8, the liquid crystal molecules 31 may be tilted in directions parallel to length directions of the minute branch portions 194a, 194b, 194c, and 194d. Since each basic electrode 199 includes the four subregions Da to Dd in which the length directions of the minute branch portions 194a, 194b, 194c, and 194d are different, the liquid crystal molecules 31 may substantially have four different tilt directions such that four domains in which alignment directions of the liquid crystal molecules 31 are different are created in the liquid crystal layer 3. As such, when the liquid crystal molecules 31 are tilted in various directions, a reference viewing angle of the LCD may become wider.

As described above, the liquid crystal display according to the embodiment of the present invention may include different additives in alignment layers of an upper and lower substrates thereof, thereby improving afterimages in a flat liquid crystal display or a curved liquid crystal display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate;
a second substrate facing the first substrate;
a pixel electrode disposed on the first substrate;
a common electrode disposed on the first substrate or the second substrate;
a first alignment layer disposed on the first substrate, and including a first additive;
a second alignment layer disposed on the second substrate, and including a second additive; and
a liquid crystal layer disposed between the first substrate and the second substrate, wherein
each of the first additive and the second additive comprises different compounds from each other and the compounds are represented by the following Chemical Formula 1; and
a molecular weight of the second additive is greater than that of the first additive:
P-Q-R-S-R-Q-P [Chemical Formula 1]
wherein S in Chemical Formula 1 comprises at least one of compounds represented by the following Chemical Formulae: 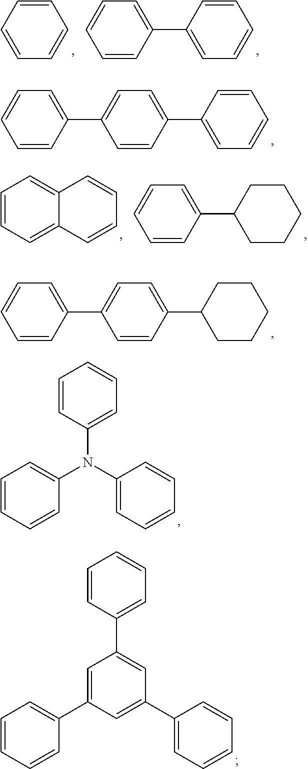
P in Chemical Formula 1 comprises at least one of compounds represented by the following Chemical Formulae: 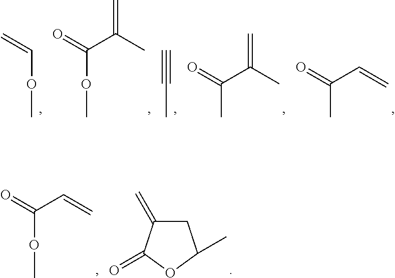
R in Chemical Formula 1 comprises at least one of compounds represented by the following Chemical Formulae: 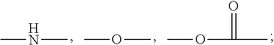
and Q in Chemical Formula 1 comprises a compound represented by the following Chemical Formula: 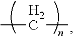
where n is an integer of 1 or more.

2. The liquid crystal display of claim 1, wherein n of the second additive is an integer of 2 or more greater than n of the first additive.

3. The liquid crystal display of claim 2, wherein the first additive is a compound represented by the following Chemical Formula 2:

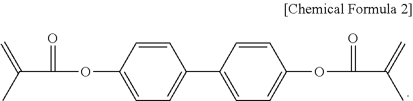 [SMILES: C=C(C)C(=O)Oc1ccc(-c2ccc(OC(=O)C(=C)C)cc2)cc1]

4. The liquid crystal display of claim 3, wherein the second additive is a compound represented by the following Chemical Formula 3:

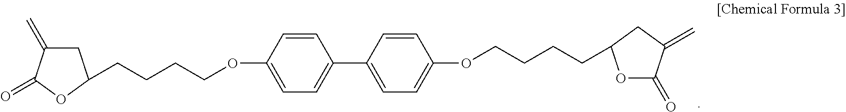 [SMILES: C=C1CC(CCCCOc2ccc(-c3ccc(OCCCCC4CC(=C)C(=O)O4)cc3)cc2)OC1=O]

5. The liquid crystal display of claim 2, wherein the first additive is greater than 5 wt % and less than 15 wt % of the first alignment layer; and the second additive is greater than 5 wt % and less than 15 wt % of the second alignment layer.

6. The liquid crystal display of claim 2, wherein the first alignment layer and the second alignment layer comprise a main chain, a plurality of side chains connected to the main chain, and an additive; and at least one of the side chains comprises a vertical expression group, and a reactive mesogen (RM) comprising a photoreactive group.

7. The liquid crystal display of claim 6, wherein the main chain of the first alignment layer and the second alignment layer comprise a diamine compound and a dianhydride compound; and the diamine compound and the dianhydride compound are contained at a 1:1 mole ratio therein.

8. The liquid crystal display of claim 6, wherein the photoreactive group comprises a photoinitiator; and the photoinitiator comprises a benzophenone-based compound.

9. The liquid crystal display of claim 8, wherein the photoinitiator comprises 20-50 mol % of the diamine compound.

10. The liquid crystal display of claim 6, wherein the first alignment layer and the second alignment layer comprise at least one of compounds represented by the following Chemical Formula 4 and Chemical Formula 5: 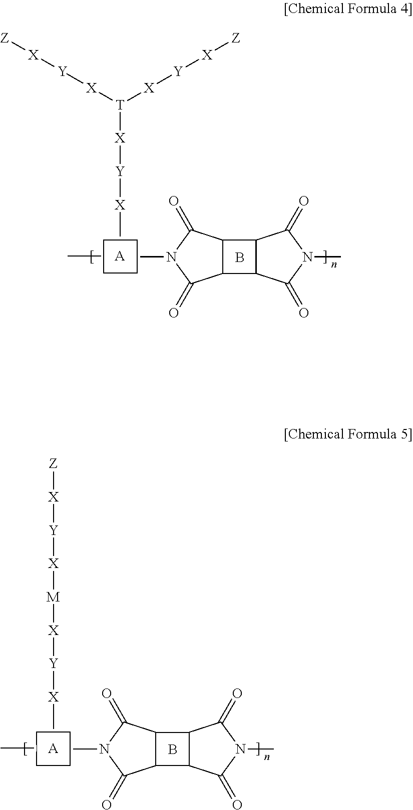
wherein A comprises at least one of compounds represented by the following Chemical Formulae: 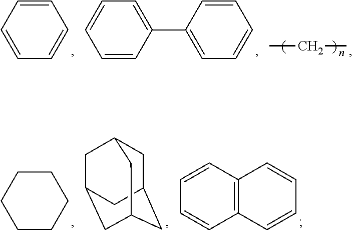
B comprises at least one of compounds represented by the following Chemical Formulae: 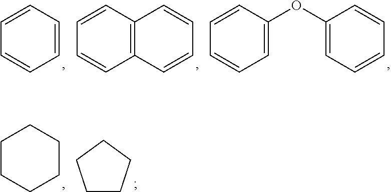
X independently comprises at least one of compounds represented by the following Chemical Formulae: 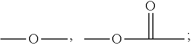
Y independently comprises at least one of compounds represented by the following Chemical Formulae: 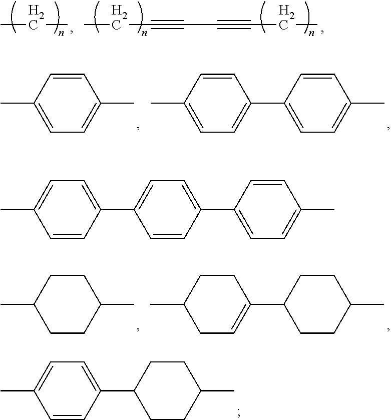
T independently comprises at least one of compounds represented by the following Chemical Formulae: 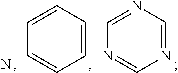
M independently comprises at least one of compounds represented by the following Chemical Formulae: 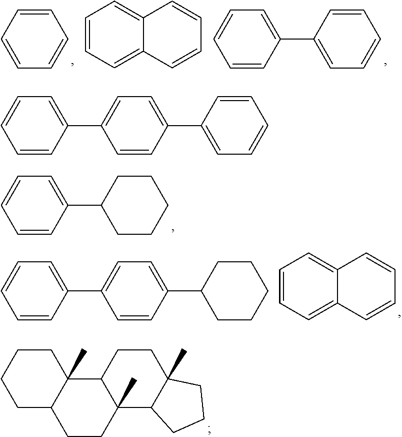
and Z independently comprises at least one of compounds represented by the following Chemical Formulae: 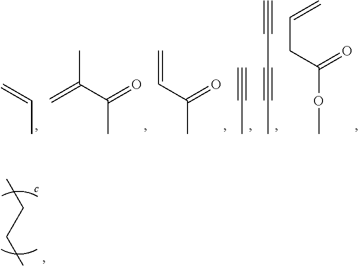
where n is an integer of 1 or more.

11. The liquid crystal display of claim 10, wherein the compound represented by the Chemical Formula 4 is a compound represented by the following Chemical Formula 6, and the compound represented by the Chemical Formula 5 is a compound represented by the following Chemical Formula 7:

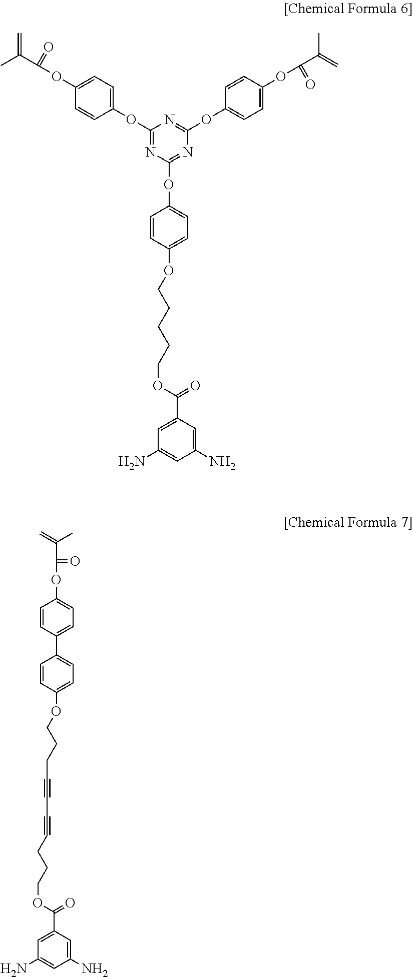 [SMILES: C=C(C)C(=O)Oc1ccc(Oc2nc(Oc3ccc(OCCCCCOC(=O)c4cc(N)cc(N)c4)cc3)nc(Oc3ccc(OC(=O)C(=C)C)cc3)n2)cc1 ; C=C(C)C(=O)Oc1ccc(-c2ccc(OCCCC#CC#CCCCOC(=O)c3cc(N)cc(N)c3)cc2)cc1]

12. A manufacturing method of a liquid crystal display, comprising:
forming a pixel electrode on a first substrate;
forming a common electrode on the first substrate or on a second substrate facing the first substrate; and
forming a first alignment layer comprising a first, additive on tire first, substrate, and a second alignment layer comprising a second additive on the second substrate, respectively, wherein
each of the first additive and the second additive comprises different compounds from each other and the compounds are represented by the following Chemical Formula 1; and
a molecular weight of the second additive is greater than that of the first additive:
P-Q-R-S-R-Q-P [Chemical Formula 1]
wherein S in Chemical Formula 1 comprises at least one of compounds represented by the following Chemical Formulae: 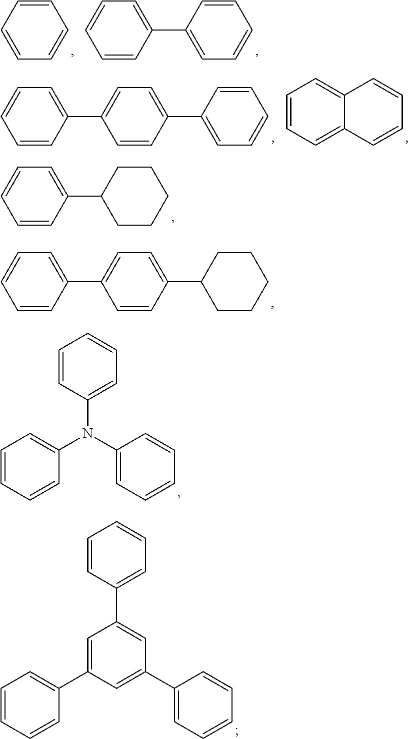
P in Chemical Formula 1 comprises at least one of compounds represented by the following Chemical Formulae: 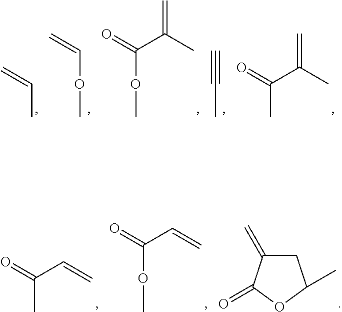
R in Chemical Formula 1 comprises at least one of compounds represented by the following Chemical Formulae: 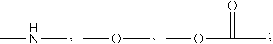
and Q in Chemical Formula 1 comprises a compound represented by the following Chemical Formula: 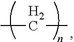
where n is an integer of 1 or more.

13. The manufacturing method of claim 11, wherein n of the second additive is an integer of 2 or more greater than n of the first additive.

14. The manufacturing method of claim 12, wherein the first additive is a compound represented by the following Chemical Formula 2; and the second additive is a compound represented by the following Chemical Formula 3:

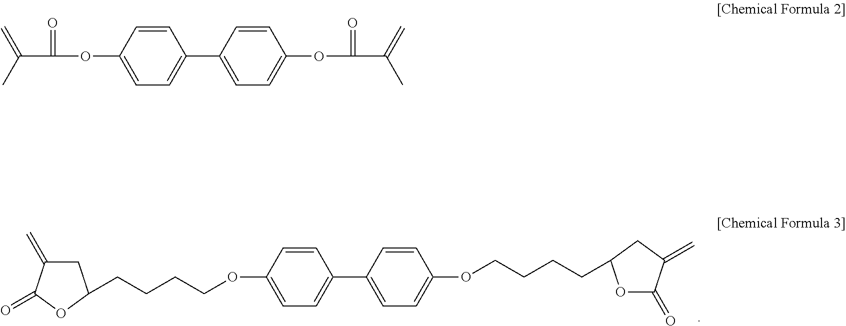 [SMILES: C=C(C)C(=O)Oc1ccc(-c2ccc(OC(=O)C(=C)C)cc2)cc1 ; C=C1CC(CCCCOc2ccc(-c3ccc(OCCCCC4CC(=C)C(=O)O4)cc3)cc2)OC1=O]

15. The manufacturing method of claim 12, wherein the first additive is 5-15 wt % of the first alignment layer; and the second additive is 5-15 wt % of the second alignment layer.

16. The manufacturing method of claim 12, wherein the first alignment layer and the second alignment layer comprise a main chain, a plurality of side chains connected to the main chain, and an additive; and at least one of the side chains comprises a vertical expression group, and a reactive mesogen including a photoreactive group.

17. The manufacturing method of claim 15, wherein the first alignment layer and the second alignment, layer comprise a diamine compound and a dianhydride compound; and the diamine compound and the dianhydride compound are contained at a 1:1 mole ratio.

18. The manufacturing method of claim 16, wherein the photoreactive group comprises a photoinitiator; the photoinitiator comprises a benzophenone-based compound; and the photoinitiator comprises 20-50 mol % of the diamine compound.

19. The manufacturing method of claim 11, wherein the first alignment layer and the second alignment layer comprise at least one of compounds represented by the following Chemical Formula 4 and Chemical Formula 5: 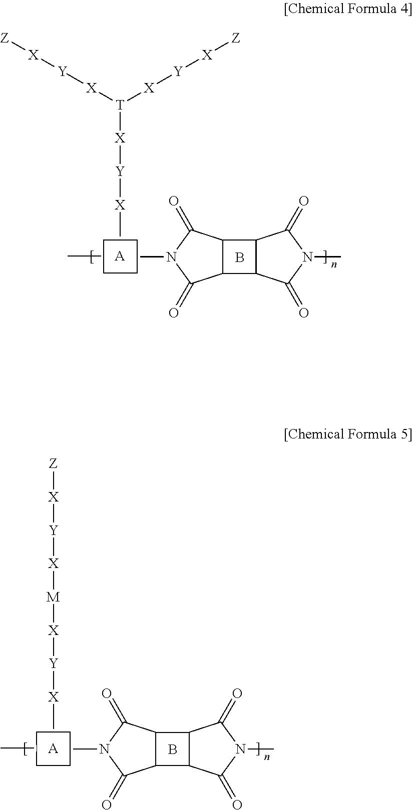
wherein A comprises at least one of compounds represented by the following Chemical Formulae: 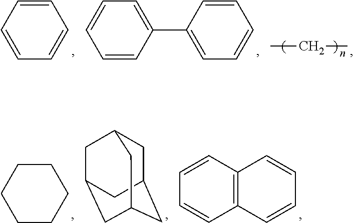
B comprises at least one of compounds represented by the following Chemical Formulae: 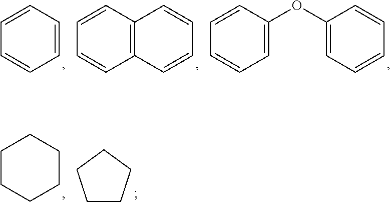
X independently comprises at least one of compounds represented by the following Chemical Formulae: 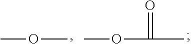
Y independently comprises at least one of compounds represented by the following Chemical Formulae: 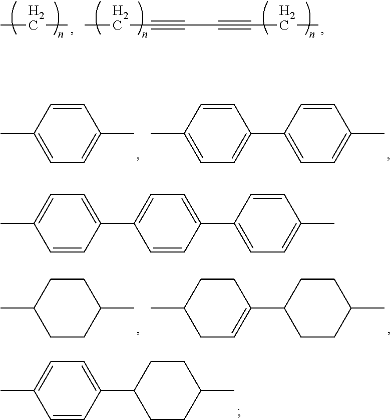
T independently comprises at least one of compounds represented by the following Chemical Formulae: 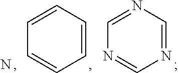
M independently comprises at least one of compounds represented by the following Chemical Formulae: 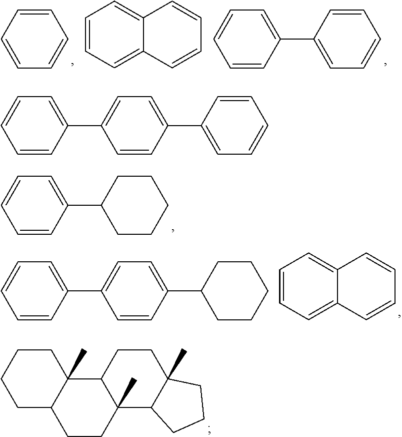
and Z independently comprises at least one of compounds represented by the following Chemical Formulae: 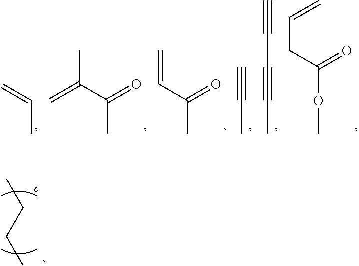
where n is an integer of 1 or more.

20. The manufacturing method of claim 12, further comprising:
injecting a liquid crystal layer between the first substrate and the second substrate after forming the alignment layer;
applying a predetermined voltage to the field-generating electrode;
performing beat treatment for the first substrate and the second substrate; and
irradiating light to the first substrate and the second substrate.
